(19) United States
(12) Patent Application Publication
(10) Pub. No.: US 2014/0173623 A1
(43) Pub. Date: Jun. 19, 2014

(54) METHOD FOR CONTROLLING TASK MIGRATION OF TASK IN HETEROGENEOUS MULTI-CORE SYSTEM BASED ON DYNAMIC MIGRATION THRESHOLD AND RELATED COMPUTER READABLE MEDIUM

(71) Applicant: MEDIATEK INC., Hsin-Chu (TW)

(72) Inventors: Shu-Hsin Chang, Hsinchu City (TW); Koan-Sin Tan, Hsinchu County (TW); Chun-Hsiung Hu, Hsinchu City (TW)

(73) Assignee: MEDIATEK INC., Hsin-Chu (TW)

(21) Appl. No.: 13/850,281

(22) Filed: Mar. 25, 2013

Related U.S. Application Data
(60) Provisional application No. 61/737,834, filed on Dec. 17, 2012.

(51) Int. Cl. G06F 9/48

(52) U.S. Cl. CPC G06F 9/4893
USPC 718/105

(57) ABSTRACT

A method for controlling a task migration of a task in a heterogeneous multi-core system having at least a first cluster and a second cluster is provided. The method may include at least the following steps: dynamically adjusting a migration threshold; comparing a load of the task running on one core of the first cluster with the migration threshold, and accordingly generating a comparison result; and selectively controlling the task to migrate to the second cluster according to at least the comparison result, wherein each core in the first cluster has first processor architecture, and each core in the second cluster has second processor architecture different from the first processor architecture.

### CROSS REFERENCE TO RELATED APPLICATIONS

This application claims the benefit of U.S. provisional application No. 61/737,834, filed on Dec. 17, 2012 and incorporated herein by reference.

### BACKGROUND

The disclosed embodiments of the present invention relate to a task migration control scheme, and more particularly, to a method for controlling a task migration of a task in a heterogeneous multi-core system based on dynamic migration threshold and related computer readable medium.

A multi-core system becomes popular nowadays due to advance of the semiconductor process. Hence, an operating system (OS) of the multi-core system frequently needs to decide whether or not a task running on a current core should migrate to a different core to maintain good load balance and/or high utilization of the system resource. Regarding a heterogeneous multi-core system, it has cores that are not identical. For example, the heterogeneous multi-core system includes at least one first core and at least one second core, where each first core has first processor architecture, and each second core has second processor architecture that is different from the first processor architecture. Hence, if the same task is running on the first core and the second core, instructions executed by the first core would be different from that executed by the second core.

In general, the first core and the second core implemented in the heterogeneous multi-core system would have different computing power due to different processor architecture. For example, the first core is a performance oriented processor core, while the second core is a power-saving oriented processor core. Hence, the computing power/capability of the first core is greater than that of the second core. When a task with heavy load and high priority is dispatched to the second core with low computing power/capacity for execution, this would result in poor system performance. In contrast, when a task with light load or low priority is dispatched to the first core with high computing power/capability for execution, this would result in poor power efficiency. Besides, to achieve better system performance, more cores in the heterogeneous multi-core system should be kept busy for task handling. However, this would result in higher power consumption. In contrast, to achieve better power-saving performance, fewer cores in the heterogeneous multi-core system should be used for task handling. However, this would result in poorer system performance.

Thus, there is a need for a task migration control mechanism which is capable of properly dispatching tasks to different cores implemented in the heterogeneous multi-core system.

### SUMMARY

In accordance with exemplary embodiments of the present invention, a method for controlling a task migration of a task in a heterogeneous multi-core system based on dynamic migration threshold and related computer readable medium are proposed to solve the above-mentioned problem.

According to a first aspect of the present invention, an exemplary method for controlling a task migration of a task in a heterogeneous multi-core system having at least a first cluster and a second cluster is disclosed. The exemplary method includes the following steps: dynamically adjusting a migration threshold; comparing a load of the task running on one core of the first cluster with the migration threshold, and accordingly generating a comparison result; and selectively controlling the task to migrate to the second cluster according to at least the comparison result, wherein each core in the first cluster has first processor architecture, and each core in the second cluster has second processor architecture different from the first processor architecture.

According to a second aspect of the present invention, an exemplary method for controlling a task migration of a task in a heterogeneous multi-core system having at least a first cluster and a second cluster is disclosed. The exemplary method includes the following steps: estimating a current available capacity of the second cluster; and selectively controlling the task running on one core of the first cluster to migrate to the second cluster according to at least the estimated current available capacity, wherein each core in the first cluster has first processor architecture, and each core in the second cluster has second processor architecture different from the first processor architecture.

According to a third aspect of the present invention, an exemplary non-transitory computer readable medium storing a program code is disclosed. When executed by a heterogeneous multi-core system having at least a first cluster and a second cluster, the program code is operative to perform a task migration control method which includes the following steps: dynamically adjusting a migration threshold; comparing a load of a task running on one core of the first cluster with the migration threshold, and accordingly generating a comparison result; and selectively controlling the task to migrate to the second cluster according to at least the comparison result, wherein each core in the first cluster has first processor architecture, and each core in the second cluster has second processor architecture different from the first processor architecture.

According to a fourth aspect of the present invention, an exemplary non-transitory computer readable medium storing a program code is disclosed. When executed by a heterogeneous multi-core system having at least a first cluster and a second cluster, the program code is operative to perform a task migration control method which includes the following steps: estimating a current available capacity of the second cluster; and selectively controlling a task running on one core of the first cluster to migrate to the second cluster according to at least the estimated current available capacity, wherein each core in the first cluster has first processor architecture, and each core in the second cluster has second processor architecture different from the first processor architecture.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a heterogeneous multi-core system according to an embodiment of the present invention.

FIG. 2 is a diagram illustrating the task migration control performed by a migration control unit shown in FIG. 1 according to an embodiment of the present invention.

FIG. 3 is a diagram illustrating the task migration control applied to a task according to an embodiment of the present invention.

FIG. 4 is a diagram illustrating an example of the task migration resulting from adjustment of the second migration threshold.

FIG. 5 is a diagram illustrating an example of the task migration resulting from adjustment of the first migration threshold.

FIG. 6 is a diagram illustrating a CPU capacity check mechanism according to an embodiment of the present invention.

FIG. 7 is a diagram illustrating a migration stabilizing mechanism according to an embodiment of the present invention.

FIG. 8 is a diagram illustrating an overall task migration control flow according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

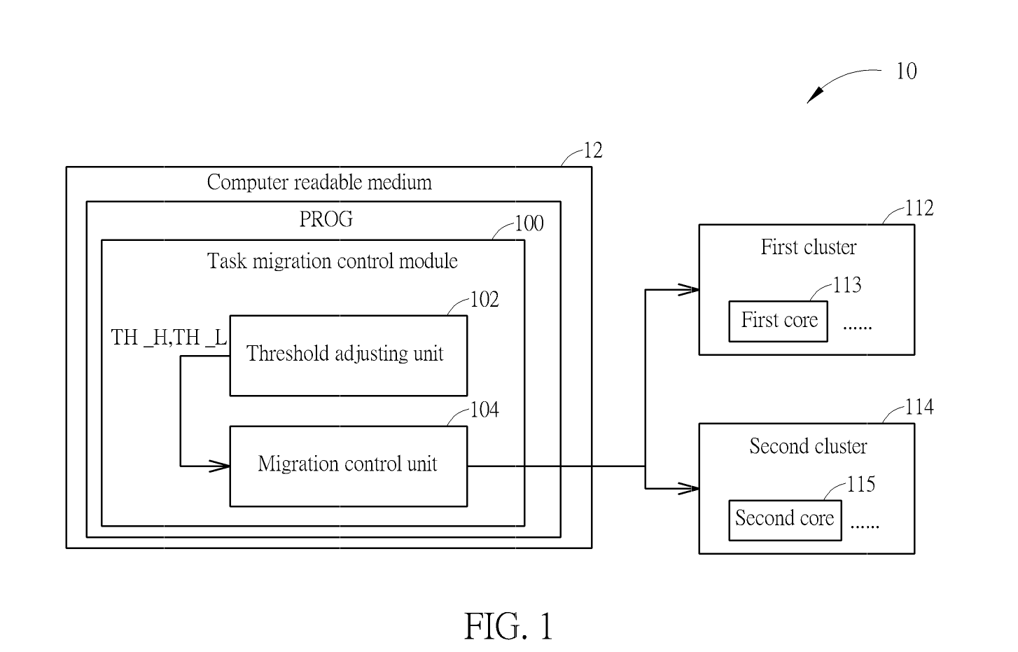

FIG. 1 is a diagram illustrating a heterogeneous multi-core system according to an embodiment of the present invention. The heterogeneous multi-core system 10 may be implemented in a portable device such as a mobile phone. However, this is not meant to be a limitation of the present invention. That is, any electronic device using the proposed task migration control method falls within the scope of the present invention. In this embodiment, the heterogeneous multi-core system 10 has a task migration control module 100 and a plurality of clusters including a first cluster 112 and a second cluster 114. The task migration control module 100 is coupled to the first cluster 112 and the second cluster 114, and arranged to perform the proposed task migration control method which is used to control tasks to migrate between the first cluster 112 and the second cluster 114. By way of example, the task migration control module 100 may be a software module performed on the heterogeneous multi-core system 10 with different clusters included therein. As shown in FIG. 1, the heterogeneous multi-core system 10 has a computer readable medium 12 such as a memory device. The computer readable medium 12 stores a program code (PROG) 14. When the program code 14 is executed by the heterogeneous multi-core system 10, the task migration control module 100 is enabled to perform the proposed task migration control method which will be detailed later.

Regarding the first cluster 112 and the second cluster 114, each cluster is a group of central processing unit (CPU) cores. That is, the first cluster 112 may include one or more first cores 113, each having the same first processor architecture; and the second cluster 114 may include one or more second cores 115, each having the same second processor architecture different from the first processor architecture. For clarity and simplicity, only one first core 113 and only one second core 115 are shown in FIG. 1. It should be noted that the number of cores included in the first cluster 112 may be identical to or different from the number of cores included in the second cluster 114.

The task migration control module 100 may be part of a scheduler and used to enable tasks in a software stack to be distributed across CPU cores in both clusters 112 and 114. Hence, at least one first core 113 and at least one second core 115 are allowed to be in operation simultaneously. In an extreme case, all of the CPU cores may be in operation simultaneously, thus achieving the optimum system performance. Besides, with the aid of the proposed task migration control method at least based on the dynamic migration threshold, a task may migrate from one core in a cluster to another core in a different cluster. The function and operation of the proposed task migration control method performed by the task migration control module 100 are detailed as below.

The threshold adjusting unit 102 is arranged to dynamically adjust a first migration threshold (e.g., an up threshold) TH_H and a second migration threshold (e.g., a down threshold) TH_L. The first migration threshold TH_H and the second migration threshold TH_L serve as parameters of the migration control unit 104. An application (e.g., a gaming application, a web surfing application, or a phone application) executed on the heterogeneous multi-core system 10 may include a plurality of tasks. Hence, the migration control unit 104 refers to the dynamic thresholds (i.e., TH_H and TH_L) and the task load of each task to control the task to migrate between the first cluster 112 and the second cluster 114. It should be noted that the task load in the present invention is related to the CPU time that the task has recently required. Therefore, the task load is a dynamic value, depending upon the instant execution status of the task running on a CPU core.

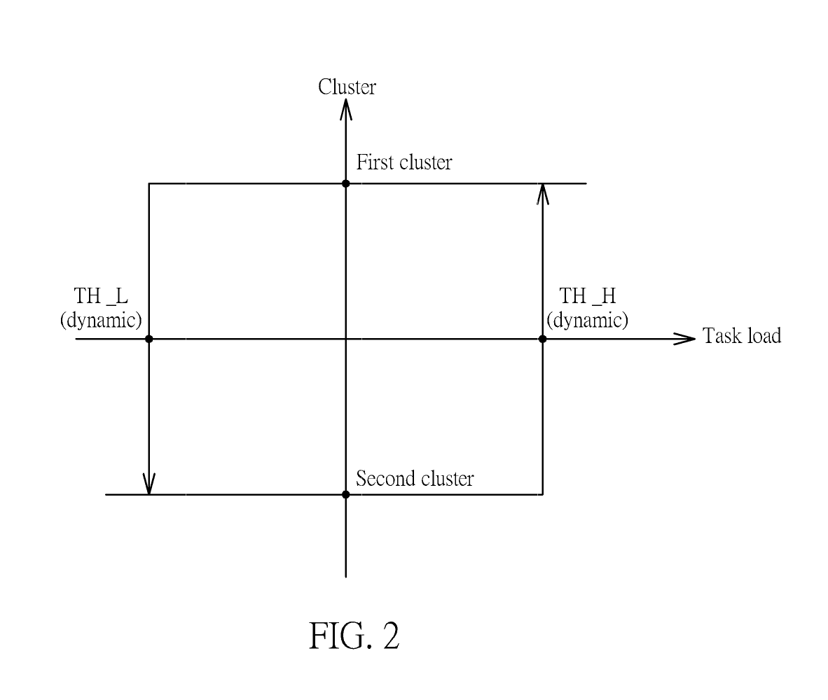

Please refer to FIG. 2, which is a diagram illustrating the task migration control performed by the migration control unit shown in FIG. 1 according to an embodiment of the present invention. The task migration bears a hysteresis characteristic. Suppose that a task with low priority is initially dispatched to the second core 115 in the second cluster 114. When the task load of the task running on the second core 115 does not increase to reach the instant value of the first migration threshold TH_H (which is adjusted dynamically), the second core 115 would keep processing the task. However, when it is determined that the task load of the task running on the second core 115 increases to reach the instant value of the first migration threshold TH_H, the migration control unit 104 would be operative to make the task migrate from the second core 115 to the first cluster 112. To put it simply, in a situation where a task is running on the second core 115 in the beginning or after migrating from the first core 113 to the second core 115, the task does not migrate from one cluster (especially, the second core 115 in the second cluster 114) to another cluster (especially, the first core 113 in the first cluster 112) unless the task load thereof reaches the instant value of the first migration threshold TH_H.

Similarly, suppose that a task is initially dispatched to the first core 113 in the first cluster 112. When the task load of the task running on the first core 113 does not decrease to reach the instant value of the second migration threshold TH_L (which is adjusted dynamically), the first core 113 would keep processing the task. However, when it is determined that the task load of the task running on the first core 113 decreases to reach the instant value of the second migration threshold TH_L, the migration control unit 104 would be operative to make the task migrate from the first core 113 to the second cluster 114. To put it simply, in a situation where a task is running on the first core 113 in the beginning or after migrating from the second core 115 to the first core 113, the task does not migrate from one cluster (especially, the first core 113 in the first cluster 112) to another cluster (especially, the second core 115 in the second cluster 114) unless the task load thereof reaches the instant value of the second migration threshold TH_L.

The present invention proposes a dynamic threshold based task migration control, thus allowing tasks of an application to migrate between different clusters (i.e., heterogeneous core groups) in a more flexible manner. For better understanding of the technical features of the present invention, a comparison between a task migration control based on dynamic thresholds and a task migration control based on fixed thresholds is detailed as below.

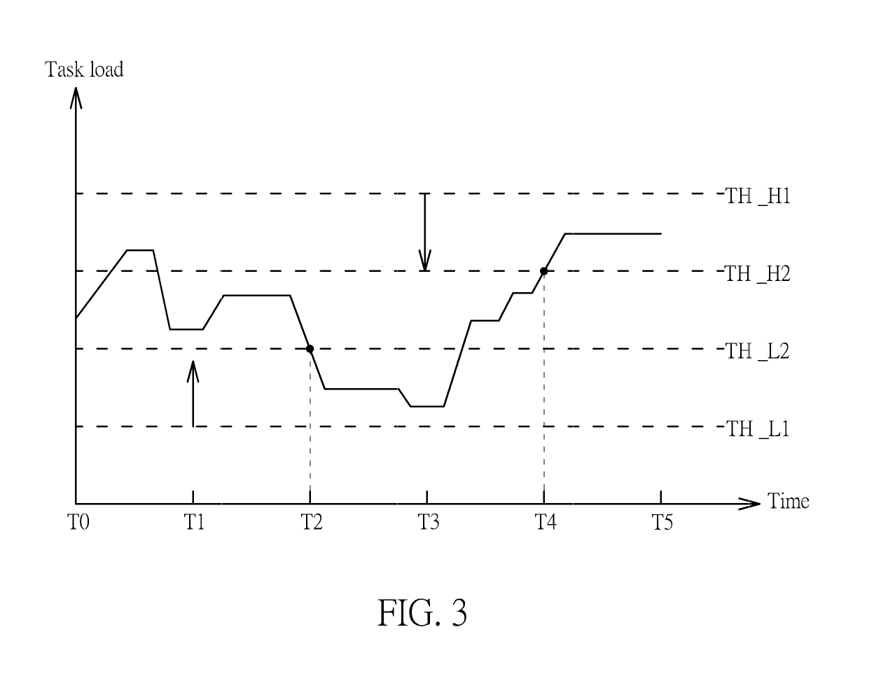

Please refer to FIG. 3, which is a diagram illustrating the task migration control applied to a task according to an embodiment of the present invention. In a first case where the first migration threshold TH_H is fixed at TH_H1 and a task is currently running on the second core 115, the task would never migrate to the first core 113 for execution during the time period between T0 and T5. In a second case where the second migration threshold TH_L is fixed at TH_L1 and a task is currently running on the first core 113, the task would never migrate to the second core 115 for execution during the time period between T0 and T5. Thus, using fixed thresholds may make tasks consistently running on one core/cluster regardless of the actual system resource utilization (i.e., the current system situation). In a worst case, all tasks are running on one cluster such that there is no task running on the other cluster. The system performance would be significantly degraded. To avoid this, the migration control unit 104 of the present invention is configured to employ dynamic thresholds instead of fixed thresholds. As shown in FIG. 3, the threshold adjusting unit 102 may reduce the first migration threshold TH_H from TH_H1 to TH_H2 (TH_H2<TH_H1) at T3. Therefore, in a third case where the first migration threshold TH_H is dynamically adjusted and a task is currently running on the second core 115/second cluster 114, the task would migrate to the first core 113/first cluster 112 at T4. Besides, as shown in FIG. 3, the threshold adjusting unit 102 may increase the second migration threshold TH_L from TH_L1 to TH_L2 (TH_L2>TH_L1) at T1. Therefore, in a fourth case where the second migration threshold TH_L is dynamically adjusted and a task is currently running on the first core 113/first cluster 112, the task would migrate to the second core 115/second cluster 114 at T2. With the aid of the proposed task migration control mechanism, the system performance of the heterogeneous multi-core system 10, such as a heterogeneous multi-core SoC (system on chip), can be improved greatly.

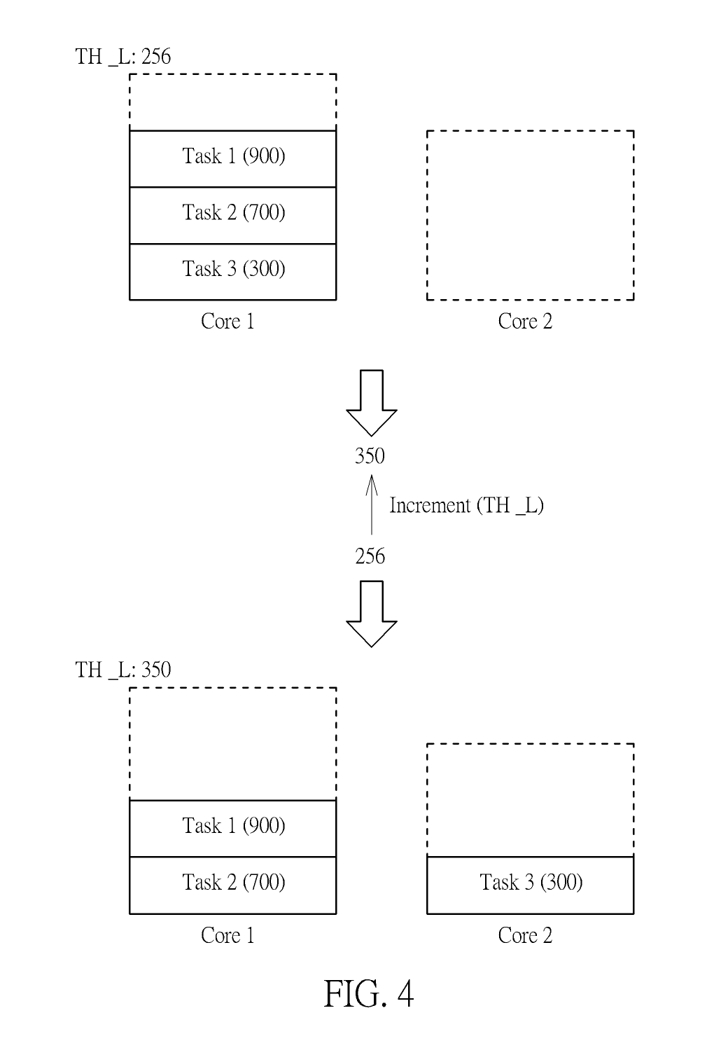

FIG. 4 is a diagram illustrating an example of the task migration resulting from adjustment of the second migration threshold TH_L. If a lot of tasks are competing for resources of first core(s) 113 in the first cluster 112, increasing the second migration threshold TH_L is capable of allowing one or more tasks running on first core(s) 113 in the first cluster 112 to migrate to second core(s) 115 in the second cluster 114. As shown in FIG. 4, when the instant value of the second migration threshold (i.e., the down threshold) TH_L is equal to 256, a first task with a task load of 900, a second task with a task load of 700 and a third task with a task load of 300 are running on the first core 113, while no task is running on the second core 115. However, after the instant value of the second migration threshold (i.e., the down threshold) TH_L is increased to 350, the third task would migrate to the second core 115 since its task load (300) is lower than the second migration threshold TH_L (350).

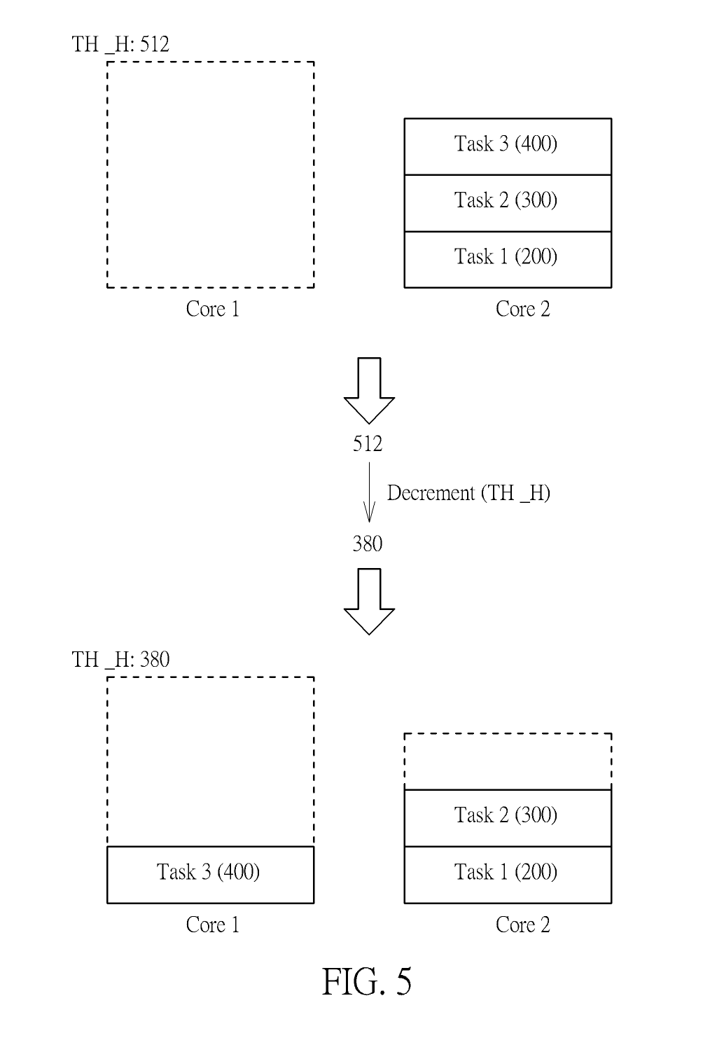

FIG. 5 is a diagram illustrating an example of the task migration resulting from adjustment of the first migration threshold TH_H. If the first core 113 is underutilized (i.e., load of the first core 113 is not heavy), decreasing the first migration threshold TH_H is capable of allowing one or more tasks on the second core(s) 115 in the second cluster 114 to migrate to first core(s) 113 in the first cluster 112. As shown in FIG. 5, when the instant value of the first migration threshold (i.e., the up threshold) TH_H is equal to 512, a first task with a task load of 200, a second task with a task load of 300 and a third task with a task load of 400 are running on the second core 115, while no task is running on the first core 113. However, after the instant value of the first migration threshold (i.e., the up threshold) TH_H is decreased to 380, the third task would migrate to the first core 113 since its task load (400) is higher than the first migration threshold TH_H (380).

As mentioned above, the threshold adjusting unit 102 is arranged to adjust the migration thresholds dynamically. In one exemplary design, the threshold adjusting unit 102 may refer to the system situation of the heterogeneous multi-core system 10 to set the aforementioned first migration threshold TH_H and the second migration threshold TH_L. For example, the system situation may include performance-related factors, such as the CPU usage per core/cluster (e.g., CPU load per core/cluster and/or CPU characteristic/ratio), the predicted CPU usage per core/cluster (e.g., predicted CPU load per core/cluster and/or predicted CPU characteristic/ratio), the number of tasks per core/cluster (e.g., the number of active tasks per core/cluster and/or the number of inactive tasks per core/cluster), and/or the load difference between cores/clusters. Since the first core(s) 113 in the first cluster 112 and the second core(s) 115 in the second cluster 114 have different hardware designs and use different instructions, the first cluster 112 would have better efficiency when used to execute tasks with some task types, and the second cluster 114 would have better efficiency when used to execute tasks with other task types. Thus, the CPU characteristic/ratio of the first cluster 112 and the second cluster 114 may be used to serve as measurement of the CPU usage. It should be noted that the CPU characteristic/ratio is a known parameter after the first cluster 112 and the second cluster 114 are designed/fabricated. Besides, when a cluster includes more than one core, the tasks dispatched to the cluster may be properly assigned to multiple cores in the same cluster for load balance. Thus, one or both of the core-based value (e.g., CPU usage per core) and the cluster-based value (e.g., CPU usage per cluster) of a performance-related factor may be involved in the dynamic migration threshold calculation.

One or more of the above-mentioned performance-related factors may be checked by the threshold adjusting unit 102 to dynamically set the first migration threshold TH_H and the second migration threshold TH_L. In this way, the proposed task migration control method is capable of making the heterogeneous multi-core system 10 have optimized system performance.

In another exemplary design, the system situation of the heterogeneous multi-core system 10 may include power-related factors, such as the power budget per core/cluster, the power consumption per core/cluster, and the power constraint (e.g., thermal constraint) per core/cluster. Similarly, when a cluster includes more than one core, the tasks dispatched to the cluster may be properly assigned to multiple cores in the same cluster for load balance. Thus, one or both of the core-based value (e.g., power budge per core) and the cluster-based value (e.g., power budget per cluster) of a power-related factor may be involved in the dynamic migration threshold calculation. It should be noted that one or more of the power-related factors may be checked by the threshold adjusting unit 102 to dynamically set the first migration threshold TH_H and the second migration threshold TH_L. In this way, the proposed task migration control is capable of making the heterogeneous multi-core system 10 have optimized power-saving performance.

In yet another exemplary design, at least one of the above-mentioned power-related factors and at least one of the above-mentioned performance-related factors may be concurrently checked by the threshold adjusting unit 102 to dynamically set the first migration threshold TH_H and the second migration threshold TH_L. In this way, the proposed task migration control is capable of making the heterogeneous multi-core system 10 have balanced performance associated with task-handling and power-saving.

In addition, the migration control unit 104 may also refer to the task priority of the tasks to decide whether this task should be migrated or not. In other words, the task priority assigned to each task to be executed is a factor that affects migration judgment. For example, when it is determined that the task load of a task running on the first core 113 decreases to reach the instant value of the dynamically-adjusted second migration threshold TH_L and the priority of the task permits a task migration from the first cluster 112 to the second cluster 114, the migration control unit 104 therefore decides to make the task migrate to the second cluster 114 for execution. Similarly, when it is determined that the task load of a task running on the second core 115 increases to reach the instant value of the dynamically-adjusted first migration threshold TH_H and the priority of the task permits a task migration from the second cluster 114 to the first cluster 112, the migration control unit 104 therefore decides to make the task migrate to the first cluster 112 for execution. Specifically, in one exemplary design, a task with low priority must migrate to a less powerful cluster (i.e., the second cluster 114) even through its task load is not beneath the instant value of the second migration threshold TH_L.

To put it simply, the factors that affect the migration threshold setting may include at least the system situation (e.g., performance-related factor(s) and/or power-related factor(s)), and the factors that affect the migration judgment may include at least the task priority.

In above embodiment, both of the up threshold (i.e., the first migration threshold TH_H) and the down threshold (i.e., the second migration threshold TH_L) are dynamically adjusted by the threshold adjusting unit 102. In one alternative design, the threshold adjusting unit 102 may be configured to refer to the system situation to dynamically adjust one of the up threshold and the down threshold while leaving the other of the up threshold and the down threshold unchanged (i.e., fixed). This also falls within the scope of the present invention.

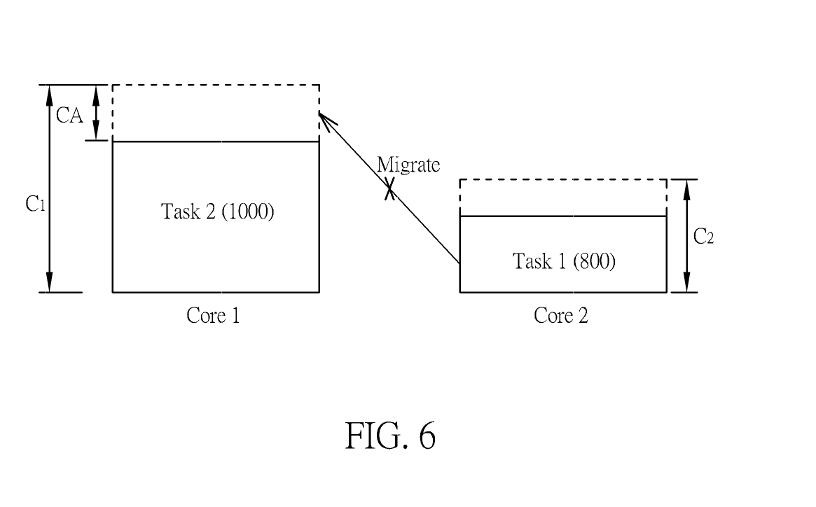

In addition to the dynamic threshold(s) provided by the threshold adjusting unit 102, the migration control unit 104 may employ addition mechanism(s) to further improve the overall task migration performance. FIG. 6 is a diagram illustrating the CPU capacity check mechanism according to an embodiment of the present invention. Basically, each core would have a capacity limit. For example, the first core 113 has a capacity limit C₁, and the second core 115 has a capacity limit C₂. As the computing power of the first core 113 is higher than that of the second core 115, the capacity limit C₁ would be higher than the capacity limit C₂. Specifically, the capacity limit of one core is reached when the core is fully loaded or has the rated maximum power consumption. In a case where the current available CPU capacity of each core is not considered, a task may migrate to a core which is almost fully loaded. As a result, more tasks are competing for the limited resource of one core, and the performance of all tasks running on this core would be affected. With regard to the example shown in FIG. 6, the second task running on the first core 113 has a task load of 1000, and the first task running on the second core 115 has a task load of 800. When the CPU capacity check mechanism is employed, the migration control unit 104 would check the current load status or power consumption of each core in a candidate cluster to estimate the current available capacity of the candidate cluster before a task actually migrates to the candidate cluster. Considering an example where the first cluster 112 has one first core 113 only and the capacity limit C₁ of the first core 113 is 1200, the migration control unit 104 finds that the current available capacity of the first cluster 112 is insufficient for the first task with the task load of 800 since the current available capacity CA of the first cluster 112 is 200 only. Hence, the migration control unit 104 would prevent the first task from migrating to the first core 113/first cluster 112. To put it another way, to reduce the chance of migrating a task to a wrong cluster, the migration control unit 104 may check CPU's available capacity to obtain cluster's available capacity before migrating any task from one cluster to another cluster.

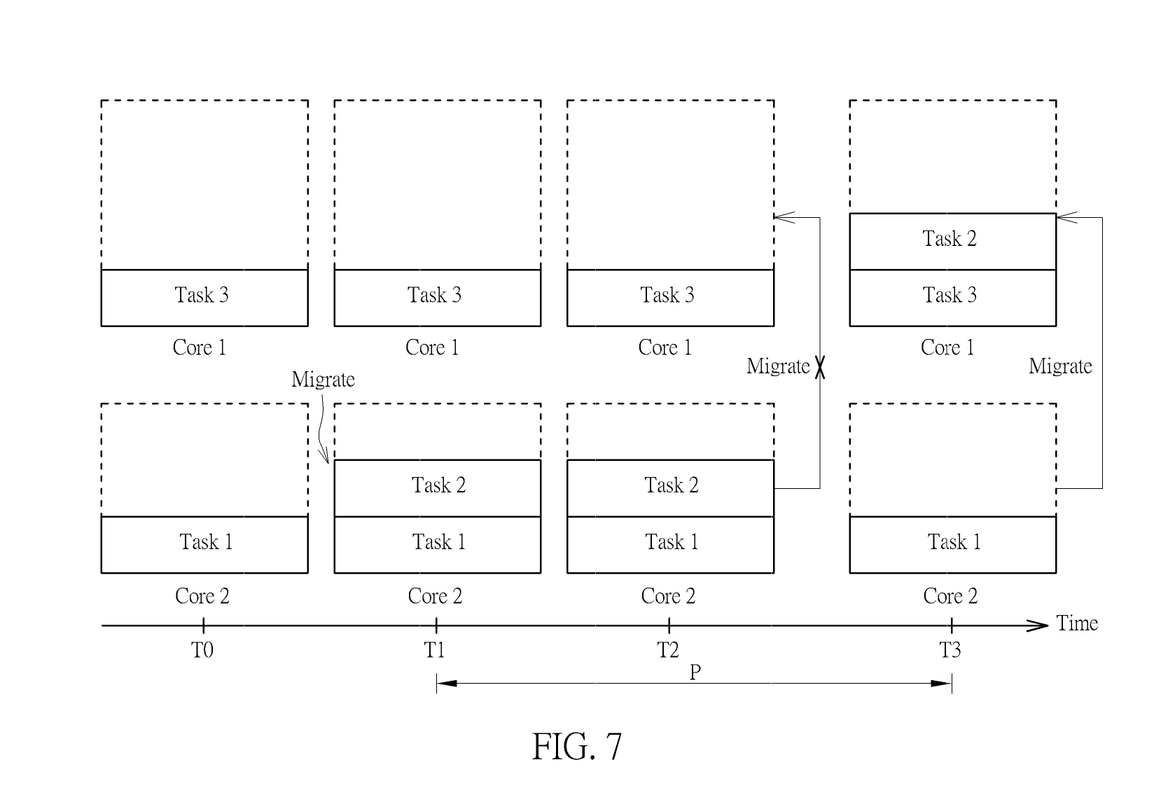

The aforementioned CPU capacity check and dynamic threshold calculation strongly depend on the preciseness of the task load. When a task just migrates to a new core of a selected cluster, the task is not executed by the new core yet. Thus, the task load may be incorrect. However, at this moment, it may have non-zero task load. If the task load of the migrated task is considered before the migrated task is actually running on the new core, the task migration control may have incorrect CPU/cluster capacity check result and dynamic threshold calculation result. Thus, to improve the preciseness of the estimated task load, the historical contribution of the task load of the migrated task running on the new core should be considered. Hence, the task has to run on the new core for a period of time and then its load is recalculated and used by the migration control unit 104 and the threshold adjusting unit 102. An embodiment of the present embodiment may be configured to include a migration stabilizing mechanism which improves the preciseness of the estimated task load, as shown in FIG. 7. At T0, the first task is executed on the second core 115 in the second cluster 114, and the third task is executed on the first core 113 in the first cluster 112. At T1, the second task migrates to the second core 115 in the second cluster 114 for execution. After this task migration is done at T1, the migration control unit 104 stops further task migration for a period of time P because the migrated second task has to run on the new CPU core (i.e., the second core 115) for the period of time P to recalculate its load. That is, the migration control unit 104 adds a next up/down migration delay to wait for the latest migrated task (i.e., the second task) to be stable on the new CPU core, and therefore prevents any task from doing a task migration until the delay has expired. As can be seen from FIG. 7, any task migration between the first core 113 and the second core 115 is not permitted at each time point (e.g., T2) within the period of time P. When the period of time P has elapsed since the second task migrated to the second core 115, the task migration between the first core 113 and the second core 115 is no long blocked at T2. In this example, the migration control unit 104 controls the second task to further migrate to the first core 113 in the first cluster 112 at T3.

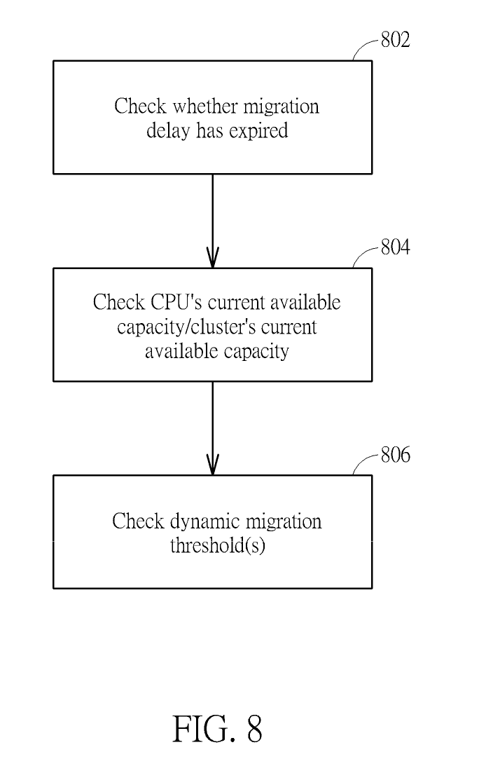

FIG. 8 is a diagram illustrating an overall task migration control flow according to an embodiment of the present invention. In this embodiment, the CPU capacity check is performed (step 804) after the migration stabilizing mechanism is done (step 802), and the dynamic migration threshold calculation is performed (step 806) after the CPU capacity check is done (step 804). It should be noted that the execution order of the migration stabilizing mechanism, the CPU capacity check and the dynamic migration threshold calculation, as shown in FIG. 8, is for illustrative purposes only. In practice, the execution order of the migration stabilizing mechanism, the CPU capacity check and the dynamic migration threshold calculation may be adjusted, depending upon actual design consideration.

Besides, using all of aforementioned mechanisms, including the migration stabilizing mechanism, the CPU capacity check, and the dynamic migration threshold calculation, to control the task migration is merely one feasible implementation of the present invention. Any task migration control design using at least one of the CPU capacity check and the dynamic migration threshold calculation would fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a task migration of a task in a heterogeneous multi-core system having at least a first cluster and a second cluster, the method comprising:
dynamically adjusting a migration threshold;
comparing a load of the task running on one core of the first cluster with the migration threshold, and accordingly generating a comparison result; and
selectively controlling the task to migrate to the second cluster according to at least the comparison result, wherein each core in the first cluster has first processor architecture, and each core in the second cluster has second processor architecture different from the first processor architecture.

2. The method of claim 1, wherein the step of dynamically adjusting the migration threshold comprises:
dynamically adjusting the migration threshold according to a system situation of the heterogeneous multi-core system.

3. The method of claim 2, wherein the system situation includes at least one performance-related factor.

4. The method of claim 3, wherein the at least one performance-related factor includes at least one of a central processing unit (CPU) usage per core/cluster, a predicted CPU usage per core/cluster, a number of tasks per core/cluster, and a load difference between cores/clusters.

5. The method of claim 2, wherein the system situation includes at least one power-related factor.

6. The method of claim 5, wherein the at least one power-related factor includes at least one of a power budge per core/cluster, a power consumption per core/cluster, and a power constraint per core/cluster.

7. The method of claim 1, wherein the step of selectively controlling the task to migrate to the second cluster comprises:
referring to the comparison result and a task priority setting of the task to selectively control the task to migrate to the second cluster.

8. The method of claim 1, further comprising:
estimating a current available capacity of the second cluster;
wherein the step of selectively controlling the task to migrate to the second cluster comprises:
referring to the comparison result and the estimated current available capacity of the second cluster to selectively control the task to migrate to the second cluster.

9. The method of claim 8, wherein the task is prevented from migrating to the second cluster as long as the estimated current available capacity of the second cluster is insufficient for the task.

10. The method of claim 1, further comprising:
controlling the task to migrate to the first cluster; and
stopping a task migration in the heterogeneous multi-core system for a predetermined period of time since the task has been migrated to the first cluster.

11. A method for controlling a task migration of a task in a heterogeneous multi-core system having at least a first cluster and a second cluster, the method comprising:
estimating a current available capacity of the second cluster; and
selectively controlling the task running on one core of the first cluster to migrate to the second cluster according to at least the estimated current available capacity, wherein each core in the first cluster has first processor architecture, and each core in the second cluster has second processor architecture different from the first processor architecture.

12. The method of claim 11, wherein the task is prevented from migrating to the second cluster as long as the estimated current available capacity of the second cluster is insufficient for the task.

13. A non-transitory computer readable medium storing a program code, wherein when executed by a heterogeneous multi-core system having at least a first cluster and a second cluster, the program code is operative to perform a task migration control method comprising:
dynamically adjusting a migration threshold;
comparing a load of a task running on one core of the first cluster with the migration threshold, and accordingly generating a comparison result; and
selectively controlling the task to migrate to the second cluster according to at least the comparison result, wherein each core in the first cluster has first processor architecture, and each core in the second cluster has second processor architecture different from the first processor architecture.

14. The non-transitory computer readable medium of claim 13, wherein the step of dynamically adjusting the migration threshold comprises:
dynamically adjusting the migration threshold according to a system situation of the heterogeneous multi-core system.

15. The non-transitory computer readable medium of claim 14, wherein the system situation includes at least one performance-related factor.

16. The non-transitory computer readable medium of claim 15, wherein the at least one performance-related factor includes at least one of a central processing unit (CPU) usage per core/cluster, a predicted CPU usage per core/cluster, a number of tasks per core/cluster, and a load difference between cores/clusters.

17. The non-transitory computer readable medium of claim 14, wherein the system situation includes at least one power-related factor.

18. The non-transitory computer readable medium of claim 17, wherein the at least one power-related factor includes at least one of a power budge per core/cluster, a power consumption per core/cluster, and a power constraint per core/cluster.

19. The non-transitory computer readable medium of claim 13, wherein the step of selectively controlling the task to migrate to the second cluster comprises:
referring to the comparison result and a task priority setting of the task to selectively control the task to migrate to the second cluster.

20. The non-transitory computer readable medium of claim 13, wherein the task migration control method further comprises:
estimating a current available capacity of the second cluster;
wherein the step of selectively controlling the task to migrate to the second cluster comprises:
referring to the comparison result and the estimated current available capacity to selectively control the task to migrate to the second cluster.

21. The non-transitory computer readable medium of claim 20, wherein the task is prevented from migrating to the second cluster as long as the estimated current available capacity of the second cluster is insufficient for the task.

22. The non-transitory computer readable medium of claim 13, wherein the task migration control method further comprises:
controlling the task to migrate to the first cluster; and
stopping a task migration in the heterogeneous multi-core system for a predetermined period of time since the task has been migrated to the first cluster.

23. A non-transitory computer readable medium storing a program code, wherein when executed by a heterogeneous multi-core system having at least a first cluster and a second cluster, the program code is operative to perform a task migration control method comprising:
estimating a current available capacity of the second cluster; and
selectively controlling a task running on one core of the first cluster to migrate to the second cluster according to at least the estimated current available capacity, wherein each core in the first cluster has first processor architecture, and each core in the second cluster has second processor architecture different from the first processor architecture.

24. The non-transitory computer readable medium of claim 23, wherein the task is prevented from migrating to the second cluster as long as the estimated current available capacity of the second cluster is not sufficient for the task.
